(19) United States
(12) Patent Application Publication
(10) Pub. No.: US 2013/0103864 A1
(43) Pub. Date: Apr. 25, 2013

(54) DEVICE FOR INDICATING STATUS OF HARD DISK

(71) Applicant: MENG-LIANG YANG, Shenzhen City (CN)

(72) Inventor: MENG-LIANG YANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/313,026

(22) Filed: Dec. 7, 2011

(30) Foreign Application Priority Data
Oct. 21, 2011 (CN) 201110322914.6

(51) Int. Cl. G06F 5/14

(52) U.S. Cl. 710/57

(57) ABSTRACT

The present invention provides a device for indicating status of hard disk. The device includes a SGPIO (Serial General Purpose Input/Output) input terminal, a serial-parallel converting unit, a buffer unit, and a status indicating unit. The serial-parallel converting unit is connected with the SGPIO input terminal and converts the serial signals into parallel signals. The buffer unit is connected with the serial-parallel converting unit and stores the parallel signals temporally. The status indicating unit is connected with the buffer unit and indicates the status of the at least one hard disk according to the parallel signals from the buffer unit.

### BACKGROUND

1. Technical Field

The disclosure relates to electronic devices and, more particularly, to a device for indicating status of a hard disk.

2. Description of Related Art

An indicating status circuit of hard disk often includes a Serial General Purpose Input/Output (SGPIO) integrated chip, such as a MG9082 chip from AMI company. However, the SGPIO integrated chip is very expensive and the circuit structure is complex.

Therefore, what is needed is a device for indicating status of hard disk to overcome the described shortcoming.

### BRIEF DESCRIPTION OF THE DRAWINGS

FIG. 1 is a block diagram of a device for indicating status of a hard disk in accordance with an exemplary embodiment.

FIG. 2 is a circuit diagram of the device of FIG. 1.

### DETAILED DESCRIPTION

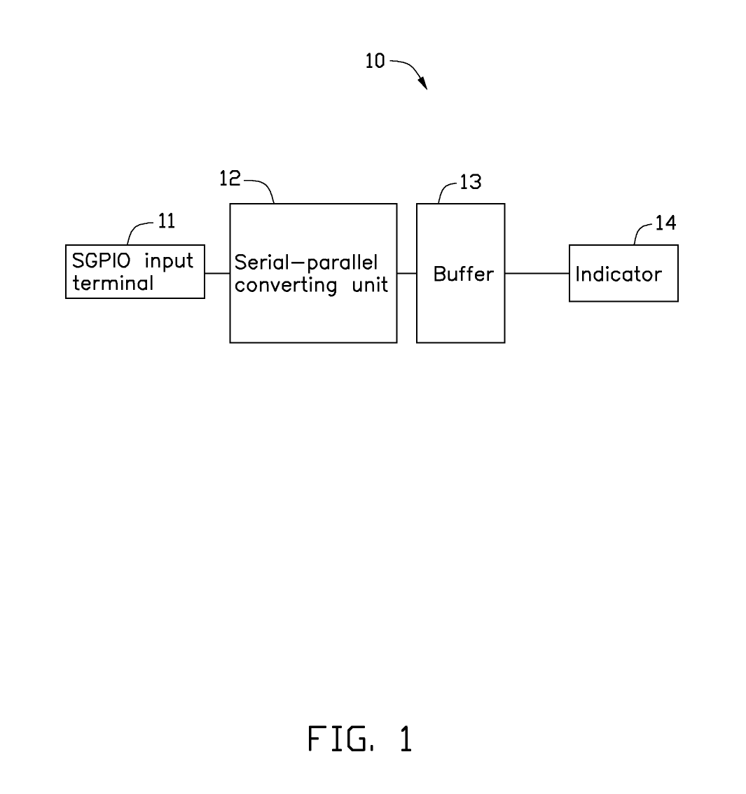

FIG. 1 is a block diagram of a device for indicating status of a hard disk in accordance with an exemplary embodiment. The device for indicating status of a hard disk (hereinafter “the device”) 10 is utilized for indicating a status of at least one hard disk. The device 10 includes a Serial General Purpose Input/Output (SGPIO) input terminal 11, a serial-parallel converting unit 12, a buffer unit 13, and a status indicating unit 14. The SGPIO input terminal 11 is connected with a control terminal (not shown) of the at least one hard disk and receives serial signals from the at least one hard disk. The serial signals represent statuses of the at least one hard disk. In this embodiment, each hard disk has three statuses, for example, such as an active status, a fault status, and a location status.

The serial-parallel converting unit 12 is connected with the SGPIO input terminal 11 and converts the serial signals into parallel signals. The buffer unit 13 is connected with the serial-parallel converting unit 12 and stores the parallel signals temporally. The status indicating unit 14 is connected with the buffer unit 13 and indicates the status of the at least one hard disk according to the parallel signals from the buffer unit 13.

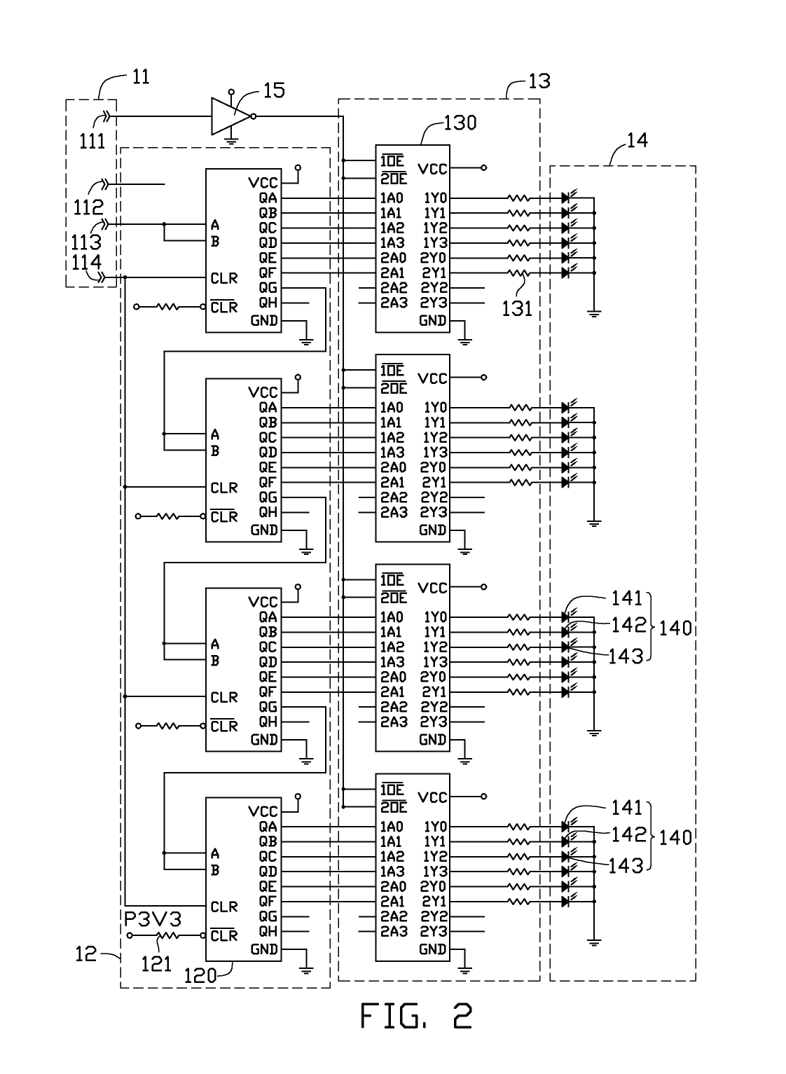

FIG. 2 is a circuit diagram of the device of FIG. 1. The SGPIO input terminal 11 includes four signal lines, which are a SLOAD signal line 111, a SDATAIN signal line 112, a SDATAOUT signal line 113, and a SLOCK signal line 114. In general, the SDATAIN signal line 112 is idle and does not transmit signals. The SLOCK signal line 114 transmits a number of clock signals. The SDATAOUT signal line 113 transmits bit streams of the serial signals from the at least one hard disk to the serial-parallel converting unit 12. For example, when the control terminal controls two hard disks, the SDATAOUT signal line 113 successively transmits the serial signals of the first hard disk and the second hard disk. Each hard disk generates three serial signals in accordance with three statuses and a rising edge of each clock signal represents a serial signal, therefore, each hard disk corresponds to three clock signals. The SLOAD signal line 111 transmits a control signal when all serial signals from the at least one hard disk are transmitted.

In the embodiment, the SDATAOUT signal line 113 transmits bit streams of the serial signals from eight hard disks, therefore, the SLOCK signal line 114 transmits twenty four clock signals. The serial-parallel converting unit 12 includes four serial-parallel converting chips 120, which are connected in series. Each serial-parallel converting chip 120 is an 8 bit chip, such as a SN74LV164 chip. Each serial-parallel converting chip 120 includes four input pins, which are an A pin, a B pin, a CLR pin, and a C̅L̅R̅ pin, and seven output pins, which are QA-QG pins.

The C̅L̅R̅ pin of each serial-parallel converting chip 120 is connected with a P3V3 voltage through a first resistance. The P3V3 voltage is a preset value. The first resistance is about 1K ohm. The CLR pin of each serial-parallel converting chip 120 is connected with the SLOCK signal line 114. The A and the B pins of the first serial-parallel converting chip 120 are connected with the SDATAOUT signal line 113. The A and the B pins of the second serial-parallel converting chip 120 are connected with the QG pin of the first serial-parallel converting chip 120. The A and the B pins of the third serial-parallel converting chip 120 are connected with the QG pin of the second serial-parallel converting chip 120. In addition, the A and the B pins of the fourth serial-parallel converting chip 120 are connected with the QG pin of the third serial-parallel converting chip 120, therefore, the four serial-parallel converting chips 120 are connected in series through the QG pin. In other embodiments, even though there could be more than four serial-parallel converting chips 120, the connections between the pins of the chips 120 are in the same connection manner as that described above. That is, the A and the B pins of the first serial-parallel converting chip 120 are connected with the SDATAOUT signal line 113, and the A and the B pins of the chip 120 except for the first serial-parallel converting chip 120 are connected with the QG pin of the previous chip 120.

When the A and the B pins of the first serial-parallel converting chip 120 receive a first serial signal from the SDATAOUT signal line 113, the first serial-parallel converting chip 120 converts the first serial signal into a first parallel signal and sends the first parallel signal to the QA pin. When the A and the B pins of the first serial-parallel converting chip 120 receive a second serial signal from the SDATAOUT signal line 113, the first serial-parallel converting chip 120 transfers the first parallel signal to the QB pin, converts the second serial signal into a second parallel signal and sends the second parallel signal to the QA pin. When the A and the B pins of the first serial-parallel converting chip 120 receive a third serial signal from the SDATAOUT signal line 113, the first serial-parallel converting chip 120 transfers the first parallel signal to the QC pin and the second parallel signal to the QB pin, converts the third serial signal into a third parallel signal and sends the third parallel signal to the QA pin.

Once the A and the B pins of the first serial-parallel converting chip 120 receive a serial signal, the first serial-parallel converting chip 120 respectively transfers current parallel signals to the following pins from QA-QF pins, converts the received serial signal to a parallel signal, and sends the parallel signal to the QA pin. After the QF pin of the first serial-parallel converting chip 120 receives a parallel signal, when the A and the B pins of the first serial-parallel converting chip 120 receive a serial signal again, the QA-QF pins of the second serial-parallel converting chip 120 starts to receive the parallel signals. In a word, after the QF pin of the chip 120 receives a parallel signal, when the A and the B pins of the first serial-parallel converting chip 120 receive a serial signal again, the QA-QF pins of the following chip 120 starts to receive the parallel signals.

The buffer unit 13 includes four buffer chips 130. Each buffer chip 130 is a 74LVC244 chip. Each buffer chip 130 includes eight input pins, such as, a 1̅O̅E̅ pin, a 2̅O̅E̅ pin, 1A0-1A3 pins, and 2A0-2A1 pins, and six output pins, such as, 1Y0-1Y3 and 2Y0-2Y1 pins. QA-QF pins of each serial-parallel converting chip 120 are respectively connected with 1A0-1A3 and 2A0-2A1 pins of the buffer chip 130. The 1̅O̅E̅ and 2̅O̅E̅ pins of each buffer chip 130 are connected with the SLOAD signal line 111 through a NAND gate (e.g., 74LVC06). 1Y0-1Y3 and 2Y0-2Y1 pins of each buffer chip 130 are respectively connected with the status indicating unit 14 through a second resistance. The second resistance is about 470K ohm.

The status indicating unit 14 includes eight groups of light emitting diode unit 140. Each group of light emitting diode unit 140 includes three light emitting diodes, which are a first light emitting diode 141, a second light emitting diode 142, and a third light emitting diode 143. The three light emitting diodes 141-143 are utilized to indicate three statuses of a hard disk. In the embodiment, each buffer chip 130 is connected with two groups of light emitting diode unit 140, therefore, the device 1 may monitor the statuses of eight hard disks.

As shown in FIG. 2, the fourth serial-parallel converting chip 120 transmits the parallel signals from the first and the second hard disks to the fourth buffer chip 130. The third serial-parallel converting chip 120 transmits the parallel signals from the third and the fourth hard disks to the third buffer chip 130. The second serial-parallel converting chip 120 transmits the parallel signals from the fifth and the sixth hard disks to the second buffer chip 130. The first serial-parallel converting chip 120 transmits the parallel signals from the seventh and the eighth hard disks to the first buffer chip 130.

Therefore, two groups of light emitting diode units 140 connected to the fourth buffer chip 130 indicate the statuses of the first and the second hard disks. Two groups of light emitting diode units 140 connected to the third buffer chip 130 indicate the statuses of the third and the fourth hard disks. Two groups of light emitting diode units 140 connected to the second buffer chip 130 indicate the statuses of the fifth and the sixth hard disks. Two groups of light emitting diode units 140 connected to the first buffer chip 130 indicate the statuses of the seventh and the eighth hard disks. In a word, the last two groups of light emitting diode units 140 connected to the last buffer chip 130 indicate the statuses of the first and the second hard disks, and the previous two groups of light emitting diode units 140 indicate the statuses of the following two hard disks.

For example, the first, second, third light emitting diodes 141, 142, 143 of the last group of light emitting diode unit 140 respectively indicate the active, fault, location statuses of the first hard disk. When the first light emitting diode 141 emits light, the first hard disk is running, and when the second light emitting diode 142 emits light, the first hard disk goes wrong.

In another embodiment, the number of the serial-parallel converting chip 120 and the number of the buffer chips 130 are changed, the device 1 may control indication of a different number of hard disks. The number of hard disks equals the sum of the number of the serial-parallel converting chips 120 and the number of the buffer chips 130. For example, when the serial-parallel converting unit 12 includes one serial-parallel converting chip 120 and the buffer unit 13 includes one buffer chip 130, the device 1 may indicate the statuses of two hard disks.

Therefore, the device 1 indicates the statuses of a number of hard disks through the serial-parallel converting chip 120 and the buffer chip 130. Because the serial-parallel converting chip 120 and the buffer chip 130 are very cheap, the device 1 can save cost for a device to indicate the status of the hard disk.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A device for indicating status of hard disk, comprising:
a Serial General Purpose Input/Output (SGPIO) input terminal, for being connected with a control terminal of at least one hard disk, to receive serial signals from the at least one hard disk;
a serial-parallel converting unit, connected with the SGPIO input terminal, to convert the serial signals into parallel signals;
a buffer unit, connected with the serial-parallel converting unit, to store the parallel signals temporally; and
a status indicating unit, connected with the buffer unit, to indicate a status of the at least one hard disk according to the parallel signals from the buffer unit.

2. The device for indicating status of hard disk as recited in claim 1, wherein the serial-parallel converting unit comprises at least one serial-parallel converting chip.

3. The device for indicating status of hard disk as recited in claim 2, wherein the serial-parallel converting chip is a SN74LV164 chip.

4. The device for indicating status of hard disk as recited in claim 3, wherein the SGPIO input terminal comprises a SDATAOUT signal line and a SLOCK signal line, each serial-parallel converting chip comprises four input pins, which are an A pin, a B pin, a CLR pin, and a C̅L̅R̅ pin, and seven output pins, which are QA-QG pins, the C̅L̅R̅ pin of each serial-parallel converting chip is connected with a voltage through a first resistance, the CLR pin of each serial-parallel converting chip is connected with the SLOCK signal line, the A and the B pins of the first serial-parallel converting chip are connected with the SDATAOUT signal line, and the A and the B pins of the serial-parallel converting chip except for the first serial-parallel converting chip are connected with the QG pin of the previous serial-parallel converting chip.

5. The device for indicating status of hard disk as recited in claim 4, wherein once the A and the B pins of the first serial-parallel converting chip receive a serial signal, the first serial-parallel converting chip respectively transfers current parallel signals to the following pins from QA-QF pins, converts the received serial signal to a parallel signal and sends the parallel signal to the QA pin, after the QF pin of the serial-parallel converting chip receives a parallel signal, when the A and the B pins of the first serial-parallel converting chip receive a serial signal again, the QA-QF pins of the following serial-parallel converting chip starts to receive the parallel signals.

6. The device for indicating status of hard disk as recited in claim 2, wherein the buffer unit comprises at least one buffer chip and the at least one buffer chip is respectively connected with the at least one serial-parallel converting chip.

7. The device for indicating status of hard disk as recited in claim 6, wherein the buffer chip is a 74LVC244 chip.

8. The device for indicating status of hard disk as recited in claim 7, wherein the SGPIO input terminal comprises a SLOAD signal line, and a 1̅O̅E̅ and a 2̅O̅E̅ pins of each buffer chip are connected with the SLOAD signal line through a NAND gate.

9. The device for indicating status of hard disk as recited in claim 8, wherein the NAND gate is a 74LVC06 chip.

10. The device for indicating status of hard disk as recited in claim 7, wherein the status indicating unit comprises at least one group of light emitting diode unit and each group of light emitting diode unit comprises three light emitting diodes, which are utilized to indicate three statuses of a hard disk, and each buffer chip is connected with two groups of light emitting diode units through a second resistance.

11. The device for indicating status of hard disk as recited in claim 10, wherein the last two groups of light emitting diode units connected to the last buffer chip indicate the statuses of the first and the second hard disks, and the previous two groups of light emitting diode units indicate the statuses of the following two hard disks.

12. The device for indicating status of hard disk as recited in claim 1, wherein the number of hard disks equals the sum of the number of the serial-parallel converting chips and the number of the buffer chips.
